(19) United States
(12) Patent Application Publication
(10) Pub. No.: US 2009/0004343 A1
(43) Pub. Date: Jan. 1, 2009

(54) Beverage systems

(76) Inventors: Wade W. Xiong, Sandy, UT (US); Danyi Wuang, Sandy, UT (US)

Correspondence Address: THORPE NORTH & WESTERN, LLP., P.O. Box 1219, SANDY, UT, 84091-1219, US

(21) Appl. No.: 12/214,894

(22) Filed: Jun. 21, 2008

Related U.S. Application Data
(63) Continuation-in-part of application No. 11/305,316, filed on Dec. 15, 2005.
(60) Provisional application No. 61/016,280, filed on Dec. 21, 2007.

(51) Int. Cl. B65D 81/32; B65D 85/72; A23L 2/52

(52) U.S. Cl. 426/115; 426/590

(57) ABSTRACT

A beverage and supplement system comprises a beverage container having: i) a liquid contained therein; and ii) a dispensive opening. A container lid is coupled to the container adjacent the dispensive opening. An envelope is contained within the container lid, the envelope being in communication with the dispensive opening of the container and having a first side sealed to a second side with said supplement being contained therebetween. The second side of the envelope is rupturable upon application of force to said first side in order to dispense said supplement from the envelope without contacting said supplement with an external object. A removable protective cover is positionable on the container lid, the protective cover restricting access to the envelope when positioned on the container lid.

### PRIORITY CLAIM

This application claims priority to copending U.S. Provisional Patent Application No. 61/016,280, filed Dec. 21, 2008, and is a continuation-in-part application of copending U.S. patent application Ser. No. 11/305,316, filed Dec. 15, 2005, each of which is hereby incorporated herein by reference in its entirety.

### FIELD OF THE INVENTION

The present invention relates generally to beverage systems. More particularly, the present invention relates to beverage systems that include a supplement component that is to be added to a beverage shortly before the beverage is consumed.

### BACKGROUND OF THE INVENTION

Beverages to which supplements have been added are consumed by many people around the world. In perhaps the simplest example, a typical such beverage is liquid, such as water, to which a supplement, such as a powdered children's drink mix (e.g., KOOL-AID® or a similar product), has been added. After mixing of the water and the supplement (and, perhaps, with the addition of an additional supplement such as sugar or a sweetener), a pleasant-tasting beverage is produced. Such systems are used to provide to consumers with fruit juice, instant coffees, teas, baby formula, medicament, etc.

While such systems generally provide to consumers a product that can be used with satisfaction in a home or office environment, transporting such beverages can prove problematic. For example, as the mixed beverage is formed of both the liquid base and the liquid or dry supplement, an end user transporting the beverage in his or her briefcase, lunchbox, car, etc., generally has to either mix the beverage prior to leaving, or must carry suitable containers for both the base liquid and the supplement.

While it is possible for some such beverages to be relatively easily transported by mixing the beverages prior to departure, some such beverages (and also some conventional “pre-mixed” beverages), exhibit a limited “shelf life,” and retain their optimal properties (e.g., taste, color, efficacy, consistency) for only a limited period of time after mixing of the beverage or after manufacture of the beverage. For example, conventional carbonated beverages and ready-to-drink beverages are often subject to short shelf lives and color change and precipitation problems during transportation and storage. Beverages containing antioxidants, vitamins, tea extracts, plant extracts, fruit extracts and vegetable extracts can also be subject to such challenges. In addition, some pharmacologically active ingredients are not stable in a liquid form, and can be subject to similar problems.

Thus, for some types of beverages it is generally desirable to mix the beverages shortly before they will be consumed, and consumers are justifiably leery of mixing them in advance of transporting them for relatively long periods of time. For a consumer to properly enjoy these types of beverages, he or she has conventionally been required to carry both the liquid (e.g. water) and the supplement (e.g. powder) and mix the two prior to consuming the beverage.

In order to address this problem, systems have been developed that allow for a small portion of supplement to be carried by, or be attached to, a fluid container such as a bottle of water. In some such systems, a quantity of the supplement is stored in the lid of the liquid container and a consumer can, through a number of manipulations, remove the supplement from the lid and add it to the contents of the container. Some systems have attempted to make this process easier by incorporating the supplement storage system into the neck of the bottle. However, by incorporating the supplement storage system into the neck of the bottle, it has conventionally been required that the supplement be contacted by some device that is external to the beverage container, such as the end user's finger or thumb, or a mechanical plunger, to extract the supplement from the storage system and deliver it to the liquid. By requiring that the supplement be contacted by some external item, the risk of contaminating the beverage with dirt, germs or other undesirable items is greatly increased.

Accordingly, while it has been attempted to provide portability to beverages that require mixing before consumption, additional delivery systems which are simple and elegant, and that prevent contaminating the supplement and/or a beverage by contact from an external object, continue to be sought.

### SUMMARY OF THE INVENTION

It has been recognized that it would be advantageous to develop a beverage system that provides for greater portability of beverages that are mixed before consumption, and that increases the shelf life and stability of mixed beverages.

Accordingly, the present invention provides a beverage and supplement system including a beverage container having: i) a liquid contained therein; and ii) a dispensive opening. A container lid can be coupled to the container adjacent the dispensive opening. An envelope can be contained within the container lid, the envelope being in communication with the dispensive opening of the container and having a first side sealed to a second side with said supplement being contained therebetween. The second side of the envelope can be rupturable upon application of force to the first side in order to dispense the supplement from the envelope without contacting the supplement with an external object. A removable protective cover can be positionable on the container lid, the protective cover restricting access to the envelope when positioned on the container lid.

In accordance with another aspect of the invention, a beverage and supplement system is provided, including a beverage container having: i) a liquid contained therein; and ii) a dispensive opening. A container lid can be threadably engaged with the container adjacent the dispensive opening. An envelope can be retained between an upper portion of the container and the container lid, the envelope being in communication with the dispensive opening of the container and having a first side sealed to a second side with said supplement being contained therebetween. The second side of the envelope can be rupturable upon application of force to the first side in order to dispense the supplement from the envelope without contacting the supplement with an external object.

In accordance with another aspect of the invention, a method for introducing a supplement to a beverage is provided, including: removing a protective cover from a container lid to expose an envelope contained within the container lid, the envelope being in communication with the dispensive opening of the container and having a first side sealed to a second side with a supplement being contained therebetween; and applying a force to the first side of the envelope to thereby rupture the second side of the envelope without rupturing the first side of the envelope to thereby dispense the supplement into the beverage without contacting the supplement with an external object.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a sectional view of a beverage container having a supplement-containing envelope in communication therewith in accordance with an embodiment of the invention;

FIG. 2 is a sectional view of another beverage container having a supplement-containing envelope in communication therewith in accordance with an embodiment of the invention;

FIG. 3 is a sectional view of another beverage container having a supplement-containing envelope in communication therewith in accordance with an embodiment of the invention;

FIG. 4 is a sectional view of another beverage container having a supplement-containing envelope in communication therewith in accordance with an embodiment of the invention;

FIG. 5A is a sectional view of a supplement-containing envelope in accordance with an embodiment of the invention;

FIG. 5B is a sectional view of the envelope of FIG. 5A, immediately after dispensing of the supplement from the envelope;

FIG. 6 is sectional view of a container holding a plurality of supplement-containing envelopes in accordance with an embodiment of the invention;

FIG. 7 is a top view of a blister pack container including a plurality of supplement-containing envelopes in accordance with an embodiment of the invention;

FIG. 8 is a partially sectioned view of a container lid in accordance with an embodiment of the invention;

FIG. 8A is a partially sectioned view of a container in accordance with another embodiment of the invention;

FIG. 9 is a partially sectioned view of another container lid in accordance with an embodiment of the invention; and

FIG. 10 is a partially sectioned view of another container lid in accordance with an embodiment of the invention.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to a “supplement” includes one or more of the supplement and reference to “supplements” includes reference to one or more of such supplements.

### DEFINITIONS

In describing and claiming the present invention, the following terminology will be used in accordance with the definitions set forth below.

As used herein, the term “supplement” refers to a material that can be added to a liquid to form a beverage of a specific and desired type. In this context, supplements include ingredient that impart flavor, color, viscosity, or other physical properties to the beverage, as well as those which provide nutritional or medicinal properties. Examples of supplements suitable for use in the present invention include, without limitation, medicaments, dietary supplements, vitamins and minerals, enzymes, powdered drink mix, beverage mix, tea, coffee, fruit and vegetable extracts and juices, etc. Additional examples include sweeteners, such as sugar, aspartame, sucralose, Stevia, saccharine, colorants, such as dyes, and other ingredients required to provide a specific physical characteristic to the beverage, such as disintegrants or diluents to improve the solubility, and carbonate or other salts in combination with an acid in order to produce effervescence.

As used herein, the term “removable” envelope is to be understood to refer to an envelope that is attached or otherwise associated with a container that can be removed from the container without causing significant damage to the envelope.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

### INVENTION

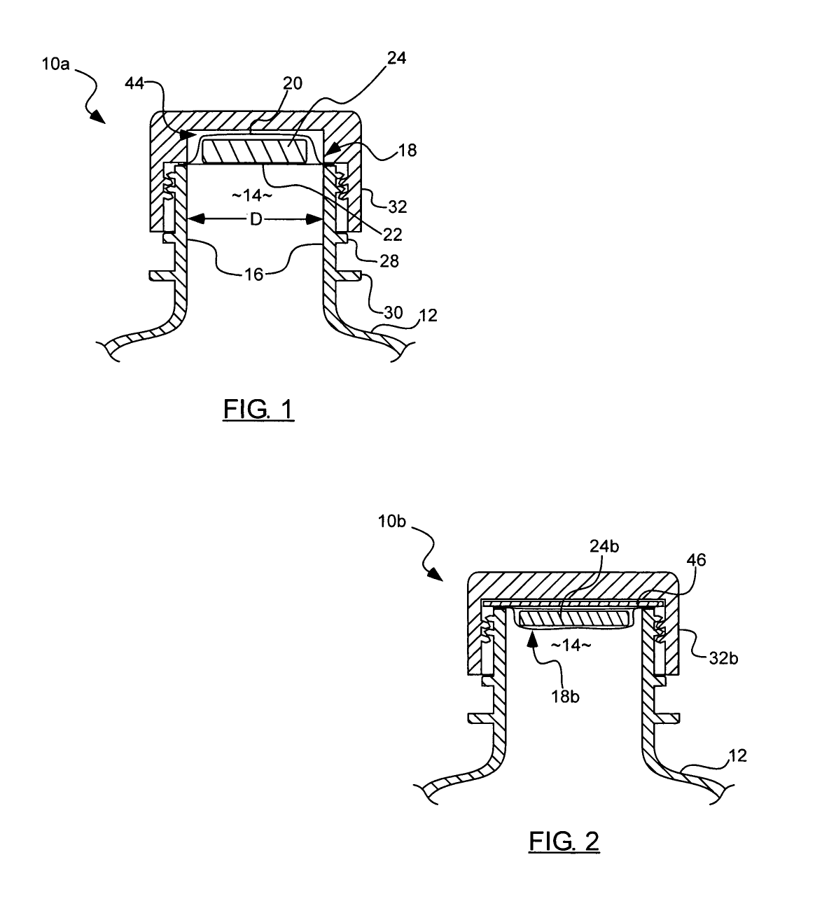

As illustrated in FIG. 1, a system, indicated generally at 10a, in accordance with the present invention is shown for an a beverage and supplement system. The system can include a beverage container 12 that can have a liquid (not shown) contained therein. The beverage container can also include a dispensive opening 14 formed or defined therein. In the embodiment shown in the figures, the dispensive opening is generally defined by the substantially cylindrical sidewall 16 of the beverage container 12. A removable envelope 18 can be in communication with the dispensive opening of the container and can have a first side 20 sealed to a second side 22 with a supplement 24 contained therebetween.

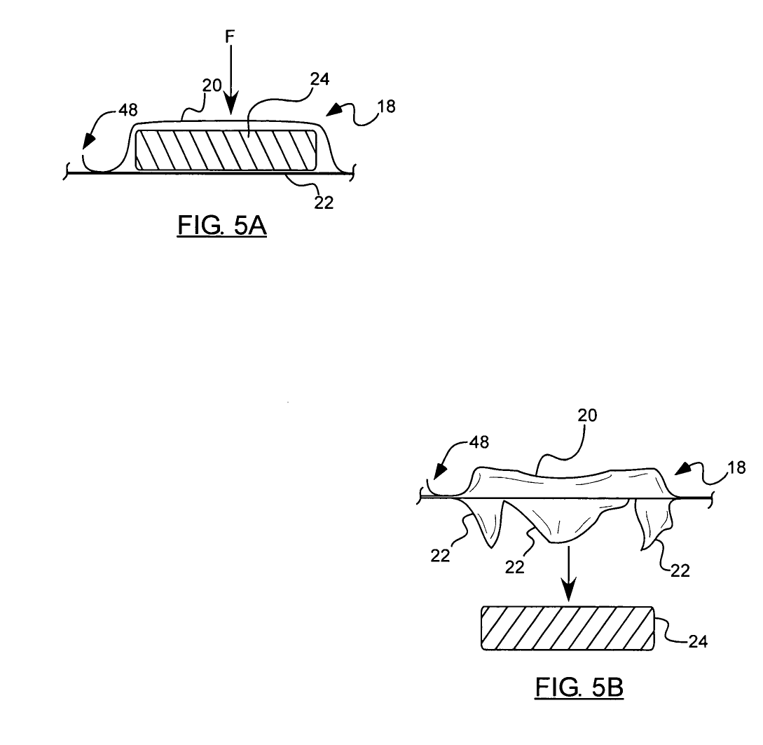

The second side 22 of the envelope can be rupturable upon application of force (“F” in FIG. 5A) to the first side 20 in an amount sufficient to rupture said second side without rupturing the first side. While not required, application of the force can result in dispensing of the supplement 24 from the envelope without contacting the supplement with an external object. Thus, the present invention provides a beverage system that allows convenient and isolated storage of a supplement with the beverage container to allow a user to add the supplement to the beverage container shortly before it is desired to consume the beverage. As the system allows the user to dispense the supplement into the beverage without contacting the supplement with an external object, dispensing of the supplement into the beverage container can be accomplished without risking contamination of the beverage or supplement with the user's unclean hands or fingers, or with a potentially unclean implement.

The liquid (not shown) utilized in the present invention can be of a variety of liquids suitable for use in many popular beverages including, without limitation, water, fruit juices, vegetable juices, coffee, tea, soft drinks, energy drinks, sports drinks, etc. Nearly any liquid is suitable for use with the present invention so long as it can benefit from being mixed with a supplement. The supplement 24 utilized in the present invention can be of a variety of forms, and can be, without limitation, in powder form, granules, liquids, and semi-solids or viscous materials, such as gels, creams, pre-concentrated botanical extracts, and mixtures thereof. The supplement can also be provided in tablet form, capsule form, loose particulate form, dry-packed, wet-packed, etc. For example, in the embodiment illustrated in FIG. 4, the supplement 24d is in a powdered or a granule form. In the embodiment illustrated in FIG. 1, the supplement 24 is in a tablet or capsule form.

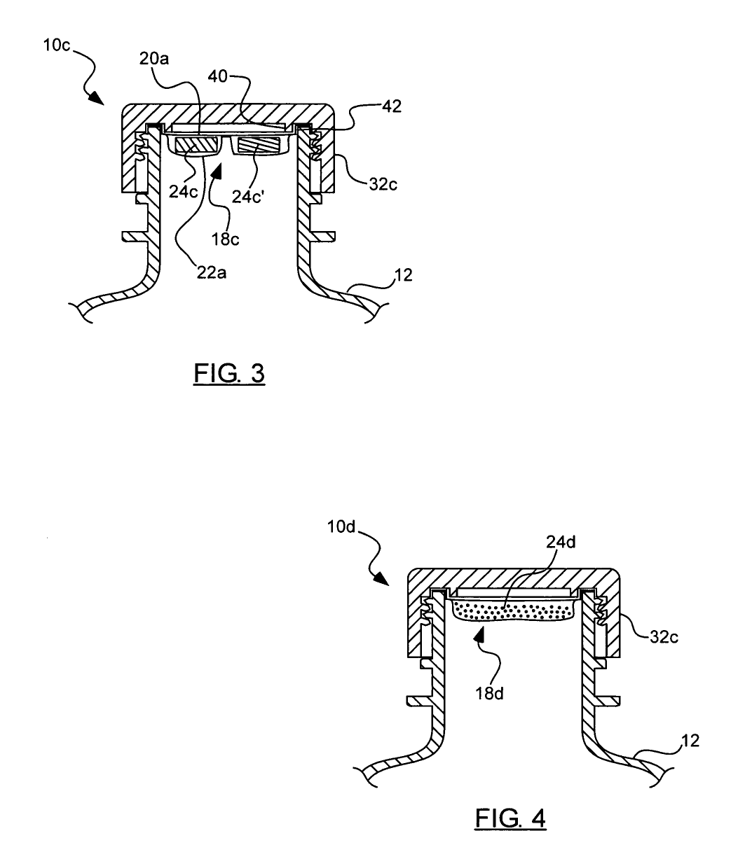

In the embodiment illustrated in FIG. 3, the supplement is provided in two distinct portions, 24c and 24c′. Multiple portions greater in number than 2, such as 3, 4, or even 5 may be used. The only restraint in this regard is the amount of space defined by the dispensive opening. Supplement 24c and 24c′ can be different types of supplement, different flavors of supplement, different colored supplement, different concentrations or formulations, etc. For example, supplement 24c can be a flavoring agent while supplement 24c′ can be a coloring agent. Also, supplement 24c can be an active ingredient while supplement 24c′ can be an effervescent agent.

The supplement can provide a variety of benefits to the liquid, such as adding flavor, nutritional value, color, smell, etc. The supplement can be, for example, tea, coffee, vitamins, antioxidants, amino acids, minerals, plant extracts, herb extracts, vegetable extracts, fruit extracts, medicament, sweeteners, flavoring agents, coloring agents, and mixtures and combinations thereof. The supplement can also include additives to increase or enhance an efficacy of the supplement, including without limitation, carriers, excipients, fillers, diluents, effervescent agents, absorption promoters, stabilizers, and disintegrants. The supplement can be effervescent tablets or granules, fast-dissolving tablets or granules, and other “instant” forms of supplement or beverages.

In other embodiments, the supplement can include effervescent tablets or granules, fast-dissolving tablets or granules, and other “instant” forms of supplement. Effervescent green tea, multi-vitamin formulations, instant green tea beverage mix or instant energy mix containing various antioxidants are also good examples of supplements for use in the present invention. In this manner, the present invention can provide, for example, a fresh green tea beverage with a high potency of green tea polyphenols that include epigallocatechin gallate (EGCG), epigallocatechin (EGC), epicatechin gallate (ECG), epicatechin (EC), gallocatechin (GC) and catechins (C).

As the type of liquid and supplement can vary widely, the type of beverage prepared for consumption by the consumer can vary widely. Due to the ability to effectively mix the supplement immediately prior to consumption, the types of beverages made available to consumers “on the go” can be expanded widely. As the supplement need not be mixed with the beverage a relatively long period of time before the beverage is consumed, formulations that have traditionally been problematic to provide in a portable format can now be made available to the general public. In addition, the use of preservatives and such additives necessary to maintain the taste, color or efficacy of conventional beverages may no longer be necessary, or may not be necessary in the quantities heretofore required. The present invention can thus provide benefits in a variety of fields of endeavor, including foods, beverages, nutraceuticals, pharmaceuticals, etc.

As the type of liquid and supplement can vary widely, so too can the type of container with which the present invention can be utilized. In the embodiments illustrated in the figures, the beverage container 12 is similar to a plastic container used extensively to provide bottled water to consumers. The container can include ridges 28, 30 between which a tamper-evident seal (not shown) can be disposed and attached to a conventional water bottle lid or cap 32. The cap or lid can be coupleable to the container via a conventional threaded connection.

The present system can be operable in containers having dispensive openings 14 with diameters “D” in a variety of ranges. In one aspect of the invention, the dispensive opening includes a diameter “D” from about 5 mm to about 100 mm. In another aspect, the diameter “D” is from about 10 mm to about 50 mm, a size range found suitable for many conventional water bottle containers. In another aspect, the diameter “D” is from about 15 mm to about 25 mm.

The present invention is advantageously adapted to be utilized with conventionally-designed and -shaped containers and lids. Also, lids tailored to specific envelope configurations can be utilized. In the embodiment illustrated at 10c in FIG. 3, the container 12 is a conventional water bottle container fitted with a conventional water bottle lid 32c. The lid 32c can include a downwardly extending flange 40 against which the upper portion of the container is cinched when closing the lid to ensure a liquid-tight seal between the lid and the container. Accordingly, in this embodiment, the removable envelope 18c can include downwardly extending portions 42 that allow the removable envelope to extend into the dispensive opening a sufficient distance to enable the flange 40 to enter the dispensive opening. In this manner, a liquid-tight seal can be created between the container and the lid, and the removable envelope will not be punctured or damage by application of the lid to the container.

Thus, in this embodiment of the invention, once the lid 32 is secured tightly against the upper portion of the container (e.g., the “rim” of the container), the lid can provide sufficient pressure to the edge of envelope 18 to limit or prevent liquid from leaking from the container. Also, as discussed elsewhere in this disclosure, adhesive can be used to removably secure the envelope over the dispensive opening. However, in those cases where the relationship between the lid and the container allows the lid to be attached to the container in a sufficiently secure manner such that leakage is prevented or limited, the removable envelope may not be bonded or adhered to the container, as the lid may secure the envelope in place without the use of adhesive. Thus, in one embodiment of the invention, the envelope can be secured to the container by way of application of force by the lid as the lid is secured to the container.

It will be appreciated that, in the embodiment of the invention illustrated in FIG. 3, portions of the removable envelope 18c can extend upwardly through extending portions 42 and over the upper portion (e.g., the rim) of the container 12, where they can be cinched tightly by application of the lid 32c to the container. In one aspect of the invention, the portions of the removable envelope 18c are removably welded or bonded to the rim of the container in this location. The first 20a and the second 22a sides of the envelope 18c can both extend past the rim of the container, or only one or the other of the first and second sides can extend past the rim of the container. Thus, in those embodiments where the material from which the first and second sides of the envelope differ, only one of the materials need extend over the top of the rim of the container, in the case that the other of the materials may be overly stiff or overly fragile such that damage to the material is a risk if it is present between the lid and the rim of the container.

In the embodiment illustrated in FIG. 1, the removable envelope 18 protrudes above the upper-most portion of the container. Consequently, the lid 32 of the embodiment in FIG. 1 can include a recessed portion 44 into which the envelope can be received. In the embodiment illustrated in FIG. 2, the lid 32b includes a gasket 46 that is configured to mate against the upper portion of the container 12 to ensure that a liquid-tight seal is formed between the lid and the container. This embodiment includes a removable envelope 18b that is substantially flush with an uppermost portion of the container 12 and that extends downwardly into the dispensive opening 14. Thus, it will be appreciated that, while the removable envelope of the present invention can be associated with the dispensive opening in a variety of manners, in one aspect of the invention, the removable envelope protrudes at partially into the dispensive opening of the container.

In another embodiment, the removable envelope 18 can be sealed over the dispensive opening of the container, providing a liquid-tight seal. The removable envelope 18 can be associated with or sealed over the dispensive opening in a variety of manners. In the embodiment illustrated in FIG. 1, the removable envelope 18 is bonded, welded or otherwise attached about the uppermost portion (e.g., rim) of the container. As the envelope can be removable to ensure that the consumer can consume the beverage after mixing, the envelope should be attached to the container in a manner that provides sufficient strength to hold the envelope in place while the supplement is forced through the second side 22 of the envelope. However, the manner in which the envelope is attached to the container should allow the envelope to be removed from about the rim of the bottle prior to consumption of the beverage (e.g., after dispensing of the supplement into the liquid).

As the materials used in the envelope and the container can vary from one application to another, the manner in which the envelope can be sealed or attached to the container can also vary. It is believed, however, that one having ordinary skill in the art of adhesives and/or plastic bonding or welding will readily grasp suitable methods of attaching the envelope to the container in a satisfactory manner.

It is contemplated that the manner in which the removable envelope is removed from the container can also vary. In one aspect of the invention, means for removing the envelope from communication with the dispensive opening of the container can be attached to the envelope. In the embodiment illustrated in FIGS. 5A and 5B, the means for removing the envelope can include a pull-tab 48 coupled to the envelope. When it is desired to remove the envelope 18 from the container, a consumer can grasp the pull-tab and peel the envelope from the container.

The removable envelope 18 can be formed from a variety of materials and in a variety of shapes and sizes. In those aspects of the invention where the supplement 24 is dispensed from the envelope by applying a force to the first side 20 of the envelope and rupturing the second side 22 of the envelope without rupturing the first side, the choice of materials used in the first and second sides can vary according to the a variety of consideration. In one aspect of the invention, the material used in the first side is a more durable material than that used in the second side, to withstand force better than the second material. The first and second sides can be formed from the same material, for example, with the first side being formed of a greater thickness than the second side, or with the first side being shaped in a manner better able to withstand force than the second side. In one embodiment of the invention, the first and second sides of the envelope are formed from a unitary piece of material, wrapped and/or folded about the supplement.

The first 20 and second 22 sides of the envelope 18 can also be formed from different materials, and selection of the materials can be governed by technology associated with so-called “blister pack” manufacturing. In these embodiments, the first side of the envelope can be formed from a “forming material,” such as polyvinyl chloride (“PVC”), polypropylene (“PP”), polyester (“PET”), polyvinylidene chloride (“PVDC”), polystyrene (“PS”), ACLAR laminates, cyclic olefin copolymer (“COC”), aluminum foil, etc., as would occur to one having ordinary skill in such fields of endeavor. The second side of the envelope can also be formed from materials known to those in the art of forming blister packs and can include known “lidding materials” such as “hard” aluminum, “soft” aluminum, paper-aluminum, paper-PET-aluminum, etc. The choice of first and second material used depends on the degree to which the product needs to be protected from light, heat and moisture.

The series of steps shown in FIGS. 5A and 5B illustrate that the removable envelope 18 can be utilized in a variety of manners. In the embodiment shown, the removable envelope 18 has been removed from the container with which it was associated without removing the supplement 24 from the envelope. It will be appreciated that application of force “F” in FIG. 5A to the first side 20 of the envelope results in the second side 22 of the envelope rupturing and dispensing the supplement from the envelope. By grasping the sides of the envelope as the force is applied, a consumer can ensure that the supplement is dispensed from the envelope into the consumer's beverage or mouth without requiring that the supplement be contacted by an external object, such as the consumer's fingers or thumb, or an implement. In this manner, the present invention allows dispensing of the supplement in a relative clean, uncontaminated manner.

The removable envelope 18 illustrated in FIGS. 5A and 5B can be associated with a container by holding the envelope over a dispensive opening of the container. Thus, the envelope need not be sold attached to a container, but can be sold separately, for example, in a package of multiple envelopes that can be provided in a sleeve, carton etc. Thus, when a consumer desires a particular beverage, he or she need only obtain a liquid in a container, such as water in a water bottle, and dispense the supplement into the container without having to contact the supplement with his or her fingers, and without requiring an external object to dispense the supplement.

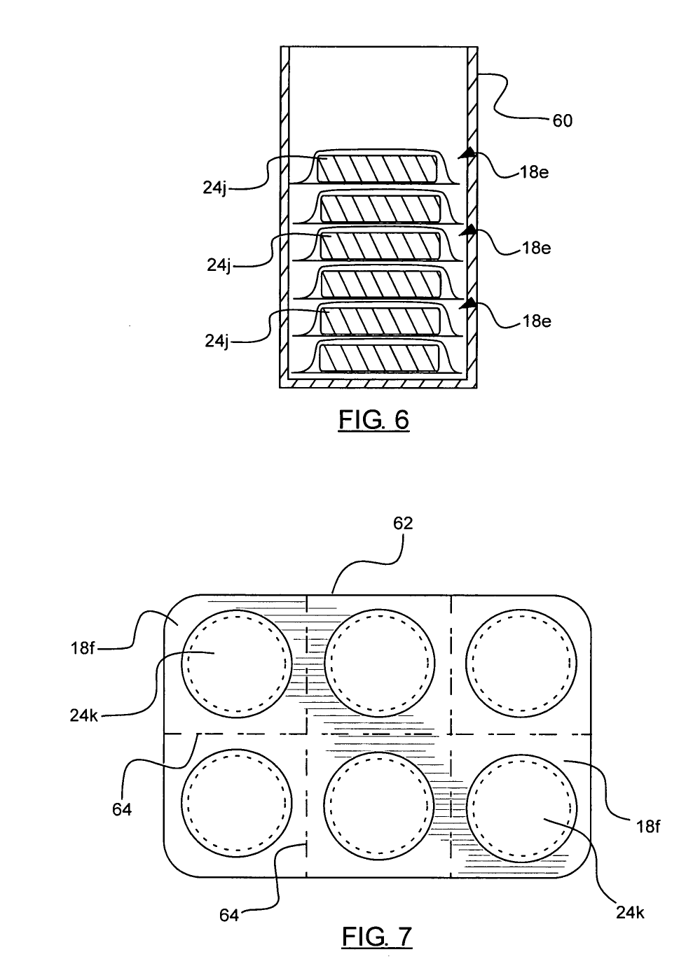

FIG. 6 illustrates a container 60 that includes a plurality of supplement-containing envelopes 18e that can each contain a supplement 24j. In this embodiment of the invention, a plurality of supplement-containing envelopes can be provided in the container and, when it is desired to consume a beverage containing the supplement, one of the supplement-containing envelopes can be removed from the container 60 and mixed with a beverage in the manner discussed above. While not so required, the container 60 of FIG. 6 can be a tubular container configured to store a plurality of disk-shaped supplement-containing envelopes.

FIG. 7 illustrates another embodiment of the invention in which a blister pack 62 is provided with a plurality of supplement-containing envelopes 18f defined by serrations or divisions 64. Each of the supplement-containing envelopes can contain a supplement 24k, as described above. The embodiments illustrated in FIGS. 6 and 7 can advantageously provide a plurality of individually dispensable supplement packets that can be sold to a consumer in a stand-alone condition to allow the consumer to selectively add the supplement to a beverage of his or her choice.

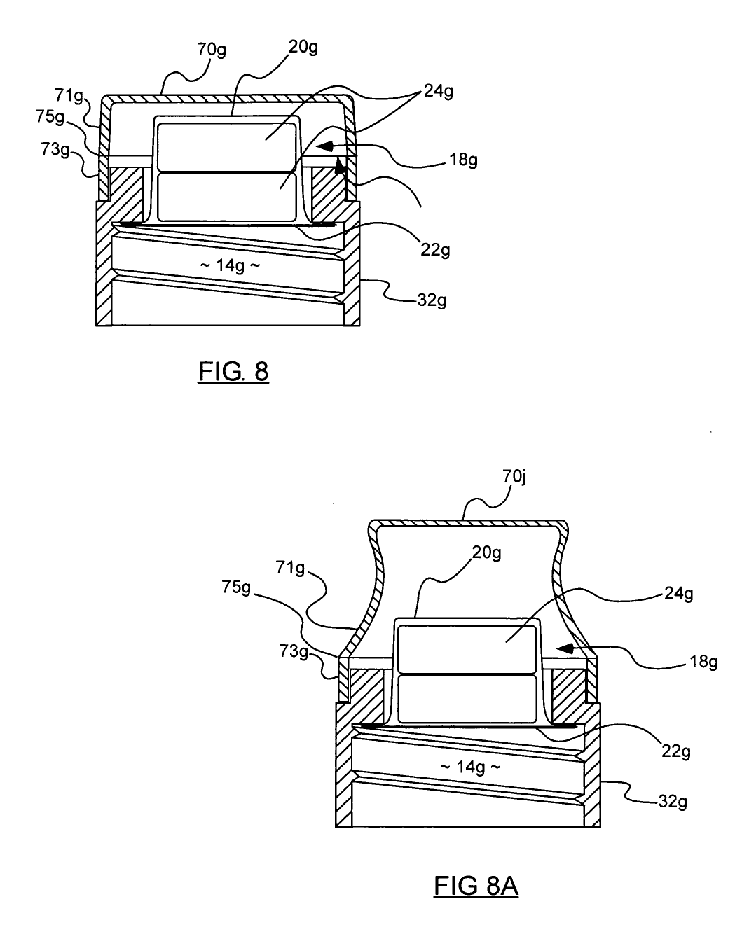

FIGS. 8, 8A, 9 and 10 illustrate further exemplary embodiments of the invention. FIG. 8 illustrates an embodiment of the invention in which envelope 18g is contained with container lid 32g adjacent dispensive opening 14g (and is thereby in communication with the dispensive opening). The envelope includes first side 20g and second side 22g, with one or more supplements 24g being contained therebetween. As in similar embodiments, the second side of the envelope can be rupturable upon application of force to said first side in order to dispense the supplement from the envelope without contacting the supplement with an external object. In this embodiment, however, a removable protective cover 70g is provided, and can be positionable on (or over) the container lid. The protective cover can serve to restrict access to the envelope when positioned on the container lid.

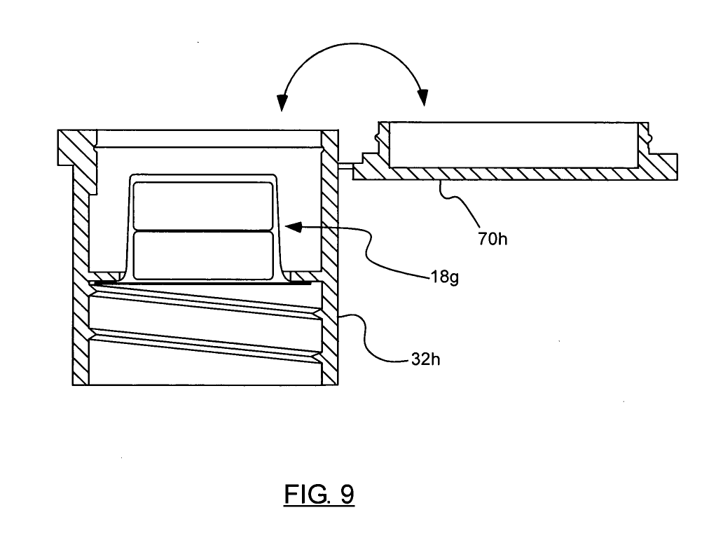

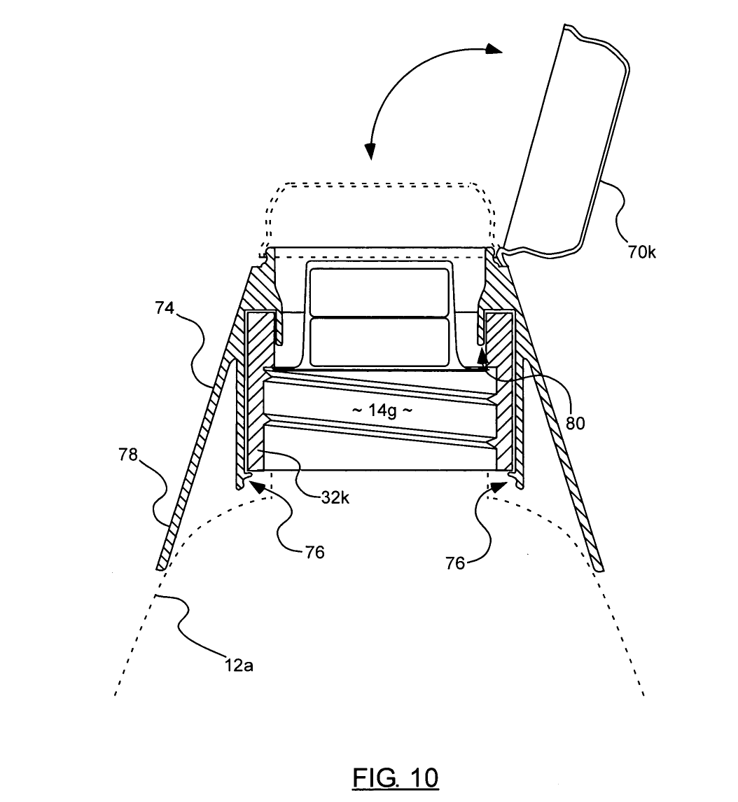

The embodiment illustrated in FIG. 8A is similar to that of FIG. 8, except that protective cover 70j is shaped to provide a more comfortable, and/or more easily manipulated, interface for a user (e.g., the user can more easily grasp and remove or otherwise manipulate the protective cover). In the embodiment illustrated in FIG. 9, protective cover 70h is hingedly coupled to container lid 32h.

This aspect of the invention can be advantageous in that installation of the supplement-bearing envelope into the system can be accomplished during manufacture or assembly of the container lid. In this manner, a facility used for filling beverage containers can be supplied with container lids pre-fitted with the supplement-bearing envelope. The beverage filling facility can then merely apply the container lid to the beverage container during the regular course of filling the containers.

In a typical scenario, a consumer can be provided with the beverage container with the container lid 32g installed upon the container, and with the envelope 18g installed within the lid. When it is desired to introduce the supplement 24g to the beverage, the consumer can remove the protective cover 70g, 70h, 70j and apply a downward (relative to the orientation of FIGS. 8, 8A and 9) force to the first side 20g of the envelope to thereby expel the supplement through the second side 22g of the envelope and into the beverage. If necessary (or desirable), the entire container lid 32g, 32h can be removed from the beverage container to facilitate consumption or pouring of the beverage from the container.

While it is anticipated that most consumers will remove the container lid 32g from the embodiment illustrated in FIGS. 8 and 8A prior to consuming the beverage contained within the container, it is contemplated that the configuration of the envelope within the lid can be such that removal of the envelope “carcass” after dispensing of the supplement can also be accomplished. In this manner, it may not be necessary to remove the container lid 32g, 32h prior to consuming the beverage/supplement mixture.

As illustrated by the embodiments of FIGS. 8, 8A and 9, the protective lid cover 70g, 70h, 70j can be advantageous in preventing tampering with the supplement prior to use of the supplement by a consumer. In the embodiment illustrated in FIG. 9, the protective cover 70h is hingedly coupled to the container lid 32h. In the embodiment illustrated in FIGS. 8 and 8A, the protective cover 70g, 70j is frictionally engaged over a portion of the container lid 32g. In either case, the protective cover can sealed to the container lid such that removal of the protective cover from the container lid creates an irreversible indication of removal of the protective cover.

In one embodiment, this can be accomplished by welding or otherwise coupling an upper portion 71g of the cover 70g, 70j to a base portion 73g of the cover (the two can be separated by “seal-line” 75g). As the upper portion must be forcefully removed from the base portion, unauthorized people may be less likely to tamper with the beverage/supplement system. Also, consumers can be thereby given an indication that someone has tampered with the system, should the seal between the two portions be broken.

In other embodiments of the invention, a protective “shrink-wrap” cover (not shown) can be applied over the container lid and protective cover to provide a tamper-resistant system. Application of shrink-wrap materials can be accomplished in a variety of manners known to those of ordinary skill in the art.

FIG. 10 illustrates a further embodiment of the invention in which protective cover 70k can be hingedly coupled to shroud cover 74. In this example, shroud cover 74 can “snap-fit” over lid portion 32k via extension prongs 76 that can engage a lower portion of the lid 32k. The protective cover can be selectively snapped into the closed position (indicated by the dashed line) to prevent accidental discharge of the beverage from the container 12a, or easily “flipped” open to the upright position shown to enable a consumer to dispense the beverage. The shroud can advantageously include a lower skirt 78 that can extend downward to mate with (or substantially conform to) sides or an upper portion of the container 12a. An inner retaining ring 80 can aid in holding the shroud on the lid 32k. This aspect of the invention can provide all of the advantages provided by other embodiments while also providing a very streamlined, aesthetically pleasing and structurally sound lid/cover system.

In addition to the structural features discussed above, the present invention also provides a method for introducing a supplement to a beverage, comprising: removing a protective cover from a container lid to expose an envelope contained within the container lid, the envelope being in communication with the dispensive opening of the container and having a first side sealed to a second side with a supplement being contained therebetween; and applying a force to the first side of the envelope to thereby rupture the second side of the envelope without rupturing the first side of the envelope to thereby dispense the supplement into the beverage without contacting the supplement with an external object.

### EXAMPLES

The following examples are illustrative of the different embodiments of the supplement of the present invention. They are representative as to typical amounts of each ingredient, and of different possible combinations of ingredients, but act in no way as a limitation thereof.

### Example 1

| Formulation | Composition (%, w/w) |
|---|---|
| Tea extracts* | 1-50 |
| Citric acid | 1-50 |
| Sodium bicarbonate | 1-50 |
| Malic acid | 1-40 |
| Tartaric acid | 1-40 |
| Potassium bicarbonate | 0-20 |
| Maltodextrin | 0-20 |
| Sorbitol | 0-20 |
| Polyethylene glycol | 0.1-5 |
| Polyplasdone XL | 0.1-5 |
| Vitamin C | 0.1-3 |
| Flavor agent | 0-3 |
| Sweetener | 0-3 |

*Tea extracts can be prepared from camellia sinensis plants and can be selected from black tea, green tea, oolong tea, and white tea. The tea extracts also can be the fine tea powder, regular extracts (with caffeine), decaffeinated tea extracts, organic tea extracts, and tea extracts containing a content of 1-99% (w/w) polyphenols, flavonoids, catechins and EGCG.

### Example 2

| Formulation | Composition (%, w/w) |
|---|---|
| Tea extracts | 1-50 |
| Vitamins¹⁾ | 0.1-10 |
| Amino acids²⁾ | 0.1-10 |
| Minerals³⁾ | 0.1-10 |
| Sodium bicarbonate | 1-50 |
| Citric acid | 1-50 |
| Malic acid | 1-40 |
| Tartaric acid | 1-40 |
| Potassium bicarbonate | 0-20 |
| Maltodextrin | 0-20 |
| Sorbitol | 0-20 |
| Calcium silicate | 0.1-5 |
| Natural fiber | 0-10 |
| Flavor agent | 0-3 |
| Sweetener | 0-3 |

¹⁾One or more vitamins can be selected from, but are not limited to, either water soluble vitamins(vitamin B₁, B₂, B₃, B₅, B₆, B₁₂, B₁₃, B₁₅, B₁₇, biotin, choline, folic acid, inositol, PABA, vitamin C, and vitamin P) or oil soluble vitamins (vitamins A, D, E and K).
²⁾One or more amino acids can be selected from, but are not limited to, alanine, arginine, carnitine, GABA, glutamine, glycine, histidine, lysine, methionine, N-acetyl cysteine, ornithine, phenylalanine, taurine, tyrosine, and valine.
³⁾One or more minerals can be selected from either cations or anions.

### Example 3

| Formulation | Composition (%, w/w) |
|---|---|
| Tea extracts | 1-50 |
| Herb/botanical extracts* | 1-50 |
| Sodium bicarbonate | 1-50 |
| Citric acid | 1-50 |
| Malic acid | 1-40 |
| Tartaric acid | 1-40 |
| Potassium bicarbonate | 0-20 |
| Maltodextrin | 0-20 |
| Sorbitol | 0-20 |
| Polyethylene glycol | 0.1-5 |
| Polyvinyl pyrrolidone | 0.1-5 |
| Flavor agent | 0-3 |
| Sweetening agent | 0-5 |

*Herbal/botanical extracts can be made from a variety of herb and botanic sources and formulated based on their therapeutic function, for example, anti-flu, bone/joint, brain function, cardiovascular, circulatory, diet, depression, digestion, energy, eye vision, general health, immune system, liver, men's health respiratory, rest, urinary tract, women's health, etc. For example, extracts can be selected from, but not limited to, Acai berry, Aloe Vera, Chamomile, Chrysanthemum, Cinnamon Bark, Coca, Cocoa, Cola, Cordyceps, Dandelion, Dan Shen, Dong Quai, Echinacea, Ginger, Ginseng, Gingko Biloba, Goji Berry, Grape seed, Gynostemma, Hawthorn berry, Hoodia, Ho Shou Wu, Kava Kava, Kelp, Licorice, Mushroom, Notoginseng, Red clover, Reshi mushroom, Rosemary, St. John's Wort, Saw Palmetto, Rose Hips, Sea Buckthorn, and mixtures thereof.

### Example 4

| Formulation | Composition (%, w/w) |
|---|---|
| Green tea extracts | 1-50 |
| Natural antioxidants* | 1-10 |
| Sodium bicarbonate | 1-50 |
| Anhydrous citric acid | 1-50 |
| Malic acid | 1-40 |
| Tartaric acid | 1-40 |
| Polyethylene glycol | 0.1-5 |
| Flavor agent | 0-3 |
| Sweetening agent | 0-5 |

*Antioxidant agents from natural sources can be selected from, but are not limited to, Grape seed, beta-carotene, co-enzyme Q-10, etc.

### Example 5

| Formulation | Composition (%, w/w) |
|---|---|
| White tea extracts | 1-50 |
| Fruit extracts* | 1-50 |
| Sodium bicarbonate | 1-50 |
| Anhydrous citric acid | 1-50 |
| Malic acid | 1-40 |
| Tartaric acid | 1-40 |
| Sorbitol | 1-20 |
| Polyvinyl pyrrolidone | 0.1-5 |
| Flavor agent | 0-3 |
| Sweetening agent | 0-5 |

*Fruit extracts can be selected from, but are not limited to, Cai berry, Apple, Apricot, Banana, Blackberry, Blue berry, Boysenberry, Cantaloupe, Cranberry, Cherry, Fig, Grape, Grapefruits, Goji berry, Guava, Guyabano fruit, Hawthorn berry, Honeydew melon, Huckleberry, Kiwi fruit, Kumquat, Lemon, Lime, Lychee, Mango, Melon, Nectarine, Noni fruit, Orange, Papaya, Peach, Pear, Persimmon, Pineapple, Plum, Pomegranate, Raspberry, Strawberry, Tangerine, Watermelon and Wild Berry.

### Example 6

| Formulation | Composition (%, w/w) |
|---|---|
| Green tea extracts | 1-50 |
| Vegetable extracts* | 1-50 |
| Sodium bicarbonate | 1-50 |
| Potassium bicarbonate | 1-50 |
| Anhydrous citric acid | 1-50 |
| Malic acid | 1-40 |
| Tartaric acid | 1-40 |
| Polyethylene glycol | 0.1-5 |
| Silica | 0.1-5 |
| Flavor agent | 0-3 |
| Sweetening agent | 0-5 |

*Vegetable extracts can be selected from, but are not limited to, Artichoke, Avocado, Asparagus, Beans, Bell Pepper, Broccoli, Brussels Sprout, Cabbage, Cauliflower, Carrot, Celery, Cucumber, Eggplant, Green bean, Lettuce, Onion, Parsley, Pea, Potato, Pumpkin, Radish, Radicchio, Rhubarb, Spinach, Tomato, Zucchini.

### Example 7

| Formulation | Composition (%, w/w) |
|---|---|
| Black tea extracts | 1-50 |
| Maltodextrin | 1-30 |
| Lactose | 0-30 |
| Sugar | 0-30 |
| Dry milk | 0-10 |
| Flavor agent | 0-3 |

### Example 8

| Formulation | Composition (%, w/w) |
|---|---|
| EGCG* | 0.1-50 |
| Maltodextrin | 5-30 |
| Mannitol | 5-30 |
| Sodium bicarbonate | 1-40 |
| Citric acid | 1-40 |
| Potassium bicarbonate | 0-20 |
| Polyplasdone | 0-10 |
| Flavor agent | 0-3 |
| Sweetening agent | 0-3 |

*EGCG can be prepared from camellia sinensis plants, the EGCG content can be 1-99% (w/w).

### Example 9

| Formulation | Composition (%, w/w) |
|---|---|
| Polyphenols* | 0.1-50 |
| Maltodextrin | 5-30 |
| Sorbitol | 5-50 |
| Sodium bicarbonate | 1-50 |
| Citric acid | 1-50 |
| Potassium bicarbonate | 0-20 |
| Silica | 0-3 |
| Flavor agent | 0-3 |
| Sweetening agent | 0-3 |

*polyphenols can be prepared from camellia sinensis plants, the content can be 1-99% (w/w).

### Example 10

| Formulation | Composition (%, w/w) |
|---|---|
| Coffee | 1-50 |
| Maltodextrin | 0-20 |
| Sorbitol | 0-20 |
| Dry milk | 0-10 |
| Sweetener | 0-3 |
| Flavor Agent | 0-3 |

### Example 11

| Formulation | Composition (%, w/w) |
|---|---|
| Cocoa | 1-40 |
| Corn syrup | 0-30 |
| Modified whey | 0-30 |
| Sugar | 0-30 |
| Milk powder | 0-10 |
| Sweetener | 0-3 |
| Flavor agent | 0-3 |

### Example 12

| Formulation | Composition (%, w/w) |
|---|---|
| Fruit extracts | 1-50 |
| Sodium bicarbonate | 1-50 |
| Citric acid | 1-50 |
| Xylitol | 5-20 |
| Crospovidone | 0-10 |
| Microcrystalline cellulose | 0-3 |
| Flavor agent | 0-3 |
| Sweetening agent | 0-5 |

### Example 13

| Formulation | Composition (%, w/w) |
|---|---|
| Vegetable extracts | 1-50 |
| Fructose | 5-30 |
| Maltodextrin | 5-30 |
| Citric acid | 1-20 |
| Starch | 0-10 |
| Flavor agent | 0-3 |
| Sweetening agent | 0-3 |

### Example 14

| Formulation | Composition (%, w/w) |
|---|---|
| Vitamins | 0.1-10 |
| Amino acids | 0.1-10 |
| Minerals | 0.01-10 |
| Caffeine | 0.1-5 |
| Citric acid | 1-50 |
| Sodium bicarbonate | 1-40 |
| Malic acid | 1-30 |
| Tartaric acid | 1-30 |
| Maltodextrin | 0-20 |
| Fructose | 0-20 |
| Flavor agent | 0-3 |
| Sweetener | 0-3 |
| Color agent | 0-2 |

### Example 15

| Formulation | Composition (%, w/w) |
|---|---|
| Herb/plant extracts | 0.1-30 |
| Vitamins | 0.1-10 |
| Amino acids | 0.1-10 |
| Minerals | 0.1-10 |
| Sodium bicarbonate | 1-50 |
| Citric acid | 1-50 |
| Sorbitol | 1-20 |
| Mineral oil | 0.1-2 |
| Flavor agent | 0-3 |
| Sweetener | 0-3 |

### Example 16

| Formulation | Composition (%, w/w) |
|---|---|
| Sodium bicarbonate | 5-50 |
| Citric acid | 5-50 |
| Fructose | 1-20 |
| Potassium bicarbonate | 0-10 |
| Flavor agent | 0-3 |
| Color agent | 0-3 |
| Sweetener | 0-3 |

### Example 17

| Formulation | Composition (%, w/w) |
|---|---|
| High fructose corn syrup | 5-50 |
| Sodium bicarbonate | 1-20 |
| Citric acid | 0-20 |
| Maltodextrin | 0-20 |
| Caramel color | 0.1-5 |
| Phosphoric acid | 0.1-5 |
| Flavor agent | 0.1-5 |
| Caffeine | 0-5 |

### Example 18

| Formulation | Composition (%, w/w) |
|---|---|
| Dry soy milk | 1-50 |
| Fructose | 0-30 |
| Mannitol | 0-30 |
| Maltodextrin | 0-20 |
| Calcium Silicate | 0.1-3 |
| Flavor agent | 0-3 |
| Sweetener | 0-3 |

### Example 19

| Formulation | Composition (%, w/w) |
|---|---|
| Dry rice milk | 1-40 |
| Fructose | 0-30 |
| Sorbitol | 0-30 |
| Starch | 0-20 |
| Calcium Silicate | 0.1-3 |
| Flavor agent | 0-3 |
| Sweetener | 0-3 |

### Example 20

| Formulation | Composition (%, w/w) |
|---|---|
| Aspirin | 0.1-10 |
| Sodium bicarbonate | 5-40 |
| Citric acid | 5-40 |
| Maltodextrin | 1-20 |
| Mannitol | 1-20 |
| Polyplasdone XL | 0-10 |
| Flavor agent | 0-3 |
| Sweetening agent | 0-3 |

### Example 21

| Formulation | Composition (%, w/w) |
|---|---|
| Active ingredients* | 0.1-20 |
| Maltodextrin | 5-30 |
| Sorbitol | 5-30 |
| Sodium bicarbonate | 5-40 |
| Citric acid | 5-40 |
| Mineral oil | 0-3 |
| Flavor agent | 0-3 |
| Sweetening agent | 0-3 |

*One or more active ingredients can be selected from pharmaceutical active ingredients.

### Example 22

| Formulation | Composition (%, w/w) |
|---|---|
| Cola nut extract | 0-5 |
| Coca leaves extract | 0-5 |
| Ginseng | 0-5 |
| B vitamin | 0-5 |
| Natural Caffeine | 0-5 |
| Maltodextrin | 5-30 |
| Mannitol | 5-30 |
| Sodium bicarbonate | 1-40 |
| Citric acid | 1-50 |
| Micro cellulose | 0-3 |
| Flavor agent | 0-3 |
| Sweetening agent | 0-5 |

### Example 23

| Formulation | Composition (%, w/w) |
|---|---|
| Taurine | 0-5 |
| Guarana | 0-5 |
| Ginseng | 0-5 |
| B vitamin | 0-5 |
| Caffeine | 0-5 |
| Maltodextrin | 1-30 |
| Sorbitol | 1-30 |
| Sodium bicarbonate | 1-40 |
| Citric acid | 1-50 |
| Malic acid | 1-30 |
| Tartaric acid | 1-30 |
| Magnesium Stearate | 0-3 |
| Flavor agent | 0-3 |
| Sweetening agent | 0-5 |

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A beverage and supplement system comprising:
a beverage container having: i) a liquid contained therein; and ii) a dispensive opening;
a container lid, coupled to the container adjacent the dispensive opening;
an envelope, contained within the container lid, the envelope being in communication with the dispensive opening of the container and having a first side sealed to a second side with said supplement being contained therebetween;
said second side of said envelope being rupturable upon application of force to said first side in order to dispense said supplement from the envelope without contacting said supplement with an external object; and
a removable protective cover, positionable on the container lid, the protective cover restricting access to the envelope when positioned on the container lid.

2. The system of claim 1, wherein the protective cover is hingedly coupled to the container lid.

3. The system of claim 1, wherein the protective cover is frictionally engaged over a portion of the container lid.

4. The system of claim 1, wherein the protective cover is sealed to the container lid such that removal of the protective cover from the container lid creates an irreversible indication of removal of the protective cover.

5. The system of claim 4, wherein the protective cover is shrink-wrapped to the container lid.

6. The system of claim 1, wherein the container lid is threadably engageable with the container, and wherein the envelope is held between an upper portion of the container and the container lid when the container lid is threadably engaged with the container.

7. The system of claim 1, wherein the supplement is in a form selected from the group consisting of: powder, granules and liquids.

8. The system of claim 1, wherein the supplement is a tablet or a capsule.

9. The system of claim 1, wherein the supplement is a member selected from the group consisting of: tea, coffee, vitamins, antioxidants, amino acids, minerals, plant extracts, herb extracts, vegetable extracts, fruit extracts, medicaments, sweeteners, flavoring agents, and coloring agents.

10. The system of claim 1, wherein the supplement includes an additive selected from the group consisting of: carriers, excipients, fillers, diluents, effervescent agents, and disintegrants.

11. A beverage and supplement system comprising:
a beverage container having: i) a liquid contained therein; and ii) a dispensive opening;
a container lid, threadably engaged with the container adjacent the dispensive opening;
an envelope, retained between an upper portion of the container and the container lid, the envelope being in communication with the dispensive opening of the container and having a first side sealed to a second side with said supplement being contained therebetween;
said second side of said envelope being rupturable upon application of force to said first side in order to dispense said supplement from the envelope without contacting said supplement with an external object.

12. The system of claim 11, further comprising a removable protective cover, positionable on the container lid, the protective cover restricting access to the envelope when positioned on the container lid.

13. The system of claim 12, wherein the protective cover is hingedly coupled to the container lid.

14. The system of claim 12, wherein the protective cover is frictionally engaged over a portion of the container lid.

15. The system of claim 12, wherein the protective cover is sealed to the container lid such that removal of the protective cover from the container lid creates an irreversible indication of removal of the protective cover.

16. The system of claim 15, wherein the protective cover is shrink-wrapped to the container lid.

17. The system of claim 11, wherein the supplement is in a form selected from the group consisting of: powder, granules and liquids.

18. The system of claim 11, wherein the supplement is a tablet or a capsule.

19. A method for introducing a supplement to a beverage, comprising:
removing a protective cover from a container lid to expose an envelope contained within the container lid, the envelope being in communication with the dispensive opening of the container and having a first side sealed to a second side with a supplement being contained therebetween;
applying a force to the first side of the envelope to thereby rupture the second side of the envelope without rupturing the first side of the envelope to thereby dispense the supplement into the beverage without contacting the supplement with an external object.

20. The method of claim 19, wherein the protective cover is hingedly coupled to the container lid.

21. The method of claim 19, wherein the protective cover is frictionally engaged over a portion of the container lid.

22. The method of claim 19, wherein the protective cover is sealed to the container lid such that removal of the protective cover from the container lid creates an irreversible indication of removal of the protective cover.

23. The method of claim 22, wherein the protective cover is shrink-wrapped to the container lid.
